(19) United States
(12) Patent Application Publication
(10) Pub. No.: US 2013/0151248 A1
(43) Pub. Date: Jun. 13, 2013

(54) Apparatus, System, and Method For Distinguishing Voice in a Communication Stream

(71) Applicant: Forrest Baker, IV, Bluffdale, UT (US)

(72) Inventor: Forrest Baker, IV, Bluffdale, UT (US)

(21) Appl. No.: 13/315,266

(22) Filed: Dec. 8, 2011

(51) Int. Cl. G10L 21/02

(52) U.S. Cl. 704/228; 704/E19.001

(57) ABSTRACT

An apparatus for distinguishing a voice is described. In one embodiment, the apparatus includes a server with a communication interface, a frame generator, and a sound analyzer. The communication interface processes an incoming communication stream with an echo canceller to cancel echo in the communication stream. The frame generator operates on a processor and generates a plurality of frames from the communication stream. Each of the plurality of frames contains data for a period of time from the communication stream. The frame generator also assigns a frame value to each of the plurality of frames. The sound analyzer determines a status of the communication stream by analyzing the frame values of the plurality of frames.

### BACKGROUND

Telemarketers process a large number of phone calls in order to maximize sales. Typically, the more phone calls that are initiated and processed, the more sales will be made. Automated dialers are used to initiate calls in many cases.

A relatively large proportion of calls are not connected to a live person. Many calls are simply not answered, while many others are answered by an answering machine or voice mail which plays a recorded voice, digital voice, or other non-live voice (collectively referred to herein as a “recorded voice”). It is important for phone call efficiency to recognize that a call has not been answered by a live person so that unanswered calls or recorded voices are not routed to agents for sales activity.

Most calling systems attempt to deal with this problem by using answering machine detectors. In order to detect answering machines, many existing systems analyze calls for a relatively long period of time. For example, some systems analyze calls for two seconds or longer in an attempt to detect an answering machine prior to transferring the call to a sales agent. As a result, a live person receiving a call from the automated dialer may be on the line for an unacceptably long time before hearing a sales agent speak.

Another drawback to answering machine detectors is that they are not very accurate. In some cases, significant percentages of live people are detected as answering machines and are cut off after answering the phone without hearing from a sales agent, or, in some cases, without hearing anything. Recipients of such terminated calls find them particularly annoying.

In response to these “dropped calls,” many jurisdictions have enacted laws that govern telemarketers and autodialers. These laws include restrictions on the length of time that a call recipient must wait before being spoken to and a limit on the percentage of dropped calls to live people. For example, the law may require that a call recipient wait no longer than two seconds after answering for communication to begin, and that no more than four percent of live call recipients be disposed of without communication.

Another drawback to answering machine detectors is that they are simply made to detect answering machines, as opposed to detecting or distinguishing live voices. As such, existing answering machine detectors are not configured to quickly detect whether the calling system is connected to a live person; only to detect whether the system is connected to a recorded voice.

Existing dialers do not produce satisfactory results or maximize efficiency. In addition, many dialers do not comply with laws restricting their use. What is needed is a system that not only detects voice, but quickly distinguishes between live voice and recorded voice.

### SUMMARY

Embodiments of a system are described. In one embodiment, the system is a system for distinguishing a voice. The system may distinguish a voice by detecting a recorded voice or be determining that the voice is live. In one embodiment, the system includes a server with a communication interface, a frame generator, and a sound analyzer. The communication interface processes an incoming communication stream with an echo canceller to cancel echo in the communication stream. The frame generator operates on a processor and generates a plurality of frames from the communication stream. Each of the plurality of frames contains data for a period of time from the communication stream. The frame generator also assigns a frame value to each of the plurality of frames. The frame values may represent a volume level, an energy level, a power level, and the like of the communication stream (collectively referred to herein as a “volume level”). The sound analyzer determines a status of the communication stream by analyzing the frame values of the plurality of frames. Other embodiments of the system are also described.

Embodiments of an apparatus are also described. In one embodiment, the apparatus is a server for distinguishing a voice. The server includes a processor, a communication interface, a frame generator, and a sound analyzer. The communication interface processes an incoming communication stream with an echo canceller to cancel echo in the communication stream. The frame generator operates on a processor and generates a plurality of frames from the communication stream. Each of the plurality of frames contains data for a period of time from the communication stream. The frame generator also assigns a frame value to each of the plurality of frames. The frame values may represent a volume level, an energy level, a power level, and the like of the communication stream (collectively referred to herein as a “volume level”). The sound analyzer determines a status of the communication stream by analyzing the frame values of the plurality of frames. Other embodiments of the server are also described.

Embodiments of a computer program product to distinguish a voice are also described. In one embodiment, the computer program product includes a computer useable storage medium to store a computer readable program that, when executed on a processor of a computer, causes the computer to perform operations for distinguishing a voice. The operations include directing a communication stream into a buffer and generating a plurality of frames. Each frame of the plurality of frames contains data for a period of time from the communication stream. The operations also include generating frame values to designate sound characteristics of the plurality of frames, establishing a silence baseline using at least some of the frame values of the plurality of frames, determining a differential between a volume level and the silence baseline, and comparing patterns of volume levels to template patterns to detect one or more of a recorded voice and a live voice. Other embodiments of the computer program product are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE SEVERAL VIEWS OF THE DRAWINGS

FIG. 1 depicts a block diagram of one embodiment of a system for distinguishing a voice.

FIG. 2 depicts a block diagram of one embodiment of the digital signal processor (DSP) of FIG. 1.

FIG. 3A depicts a block diagram of one embodiment of the sound analyzer of FIG. 2.

FIG. 3B depicts a block diagram of one embodiment of the level analyzer of FIG. 3A.

FIGS. 4A-D depict waveform diagrams of different embodiments of volume patterns associated with various communications streams.

FIG. 5 depicts a flowchart diagram showing one embodiment of a method for distinguishing a voice.

FIG. 6 depicts s flowchart diagram showing one embodiment of a method for analyzing frame volume levels to distinguish a voice.

FIG. 7 depicts a flowchart diagram showing one embodiment of a method for distinguishing a voice using template patterns and response analysis.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Embodiments of the present invention have been developed in response to the present state of the art and, in particular, in response to the problems and needs in the art that have not yet been fully solved by currently available structures and methods. Accordingly, embodiments of the invention have been developed to provide structures and methods to overcome various shortcomings of the prior art. The features and advantages of various embodiments of the invention will become more fully apparent from the following description and appended claims, or may be learned by practice of the invention as set forth hereinafter.

While many embodiments are described herein, at least some of the described embodiments distinguish voice connected to a communication stream. Some embodiments dispose of calls in response to detecting a recorded voice. Recorded voices may be detected by comparing converted volume levels to template patterns that indicate a recorded voice. Recorded voices may also be detected by analyzing a response in inbound audio to outbound audio.

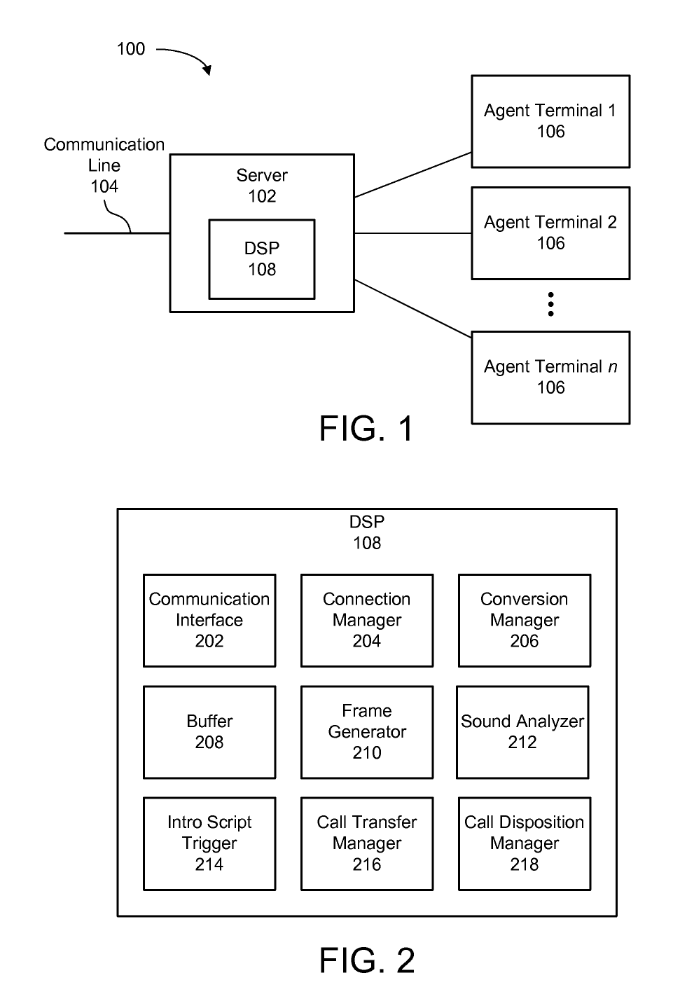

FIG. 1 depicts a block diagram of one embodiment of a system 100 for distinguishing a voice. The system 100 includes a server 102, a communication line 104, and a plurality of agent terminals 106. The system 100 analyzes a communication stream from the communication line 104 to determine if the communication stream is from a recorded voice.

The server 102, in one embodiment, is a computer capable of performing operations to distinguish a voice. The server 102 includes a digital signal processor (DSP) 108. The server also may include other processors, volatile memory, persistent memory, and input/output interfaces. An embodiment of the DSP 108 of the server 102 is described in greater detail below in relation to FIG. 2.

In some embodiments, the server 102 is a single computer. In another embodiment, the server 102 includes a plurality of computers. Functions of the server 102 may be distributed across the plurality of computers and/or DSPs 108.

The communication line 104, in one embodiment, transmits a communication stream to the server 102. The communication line 104 may be any type of transmission device capable of transmitting a communication stream. For example, the communication line 104 may be a T1 line that transmits multiple voice conversations simultaneously. In another example, the communication line 104 may be an Ethernet connection. Other embodiments may include other types of communications lines.

The communication stream transmitted by the communication line 104 may be any type of communication stream. For example, the communication stream may be a telephone call, a video call, or a voice over internet protocol (VOIP) connection. Other embodiments may include other types of communications streams.

In some embodiments, the server 102 manages the transfer of communication streams to the agent terminals 106. The server 102 may determine which communication streams to transfer based on a determination of the status of the communication stream, a current or projected load at one or more agent terminals 106, or another factor.

The one or more agent terminals 106, in one embodiment, may each be operated by an agent such as a human operator. Each agent terminal 106 may receive one or more communication streams from the server 102 to be handled by the agent. For example, an agent terminal 106 may present two simultaneous communication streams to the agent. Each simultaneous communication stream may be under processing by the server 102 to determine if the communication stream includes a recorded voice while the communication streams are presented to the agent. One or more of the presented communication streams may be determined to be a recorded voice subsequent to being presented to the agent, and in response the one or more communication streams may be removed from the agent terminal 106 and disposed.

The agent terminals 106 may be any type of terminal capable of delivering one or more communication streams to an agent. For example, each agent terminal 106 may be a computer with a processor, a display, a keyboard, and a headset for outputting and interacting with one or more communication streams.

FIG. 2 depicts a block diagram of one embodiment of the DSP 108 of FIG. 1. In general, the DSP 108 distinguishes live voices from recorded voices in communication streams. The DSP 108 also distinguishes live voices from non-voices in communication streams. In one example, the DSP 108 is a Dialogic® telephony interface board available from Dialogic Incorporated of Milpitas, Calif. The DSP 108 unit may include, without limitation, a digital telephony interface, a voice digitizing interface for computers and computer controlled telephone interfaces, an audio coupling interface between telephone and computers, a digitized voice-editing computer program, an audio multiplexer, and the like. Although the DSP 108 is shown with certain components, other embodiments may implement at least some of the functionality of those components outside of the DSP 108.

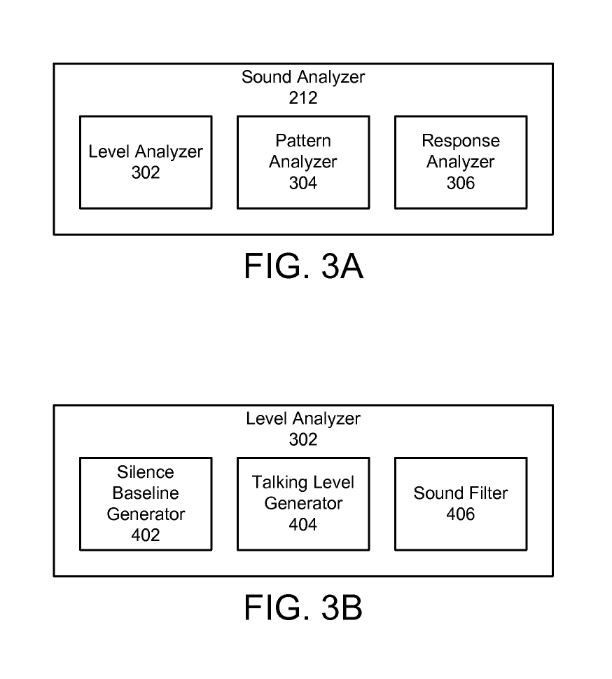

In the illustrated embodiment, the DSP 108 includes a communication interface 202, a connection manager 204, a buffer 208, a frame generator 210, a conversion manager 206, a sound analyzer 212, an intro script trigger 214, a call transfer manager 216, and a call disposition manager 218. The sound analyzer 212 may include a level analyzer 302, a pattern analyzer 304, and a response analyzer 306, as illustrated in FIG. 3A and explained in more detail below.

The communication interface 202, in one embodiment, provides a physical interface to receive the communication stream from the communication line 104. The communication interface 202 may receive a single communication stream or multiple communication streams simultaneously. The communication stream may be established through an internet connection or through another type of telephone connection. In some embodiments, the communication interface 202 includes an echo canceller (not shown) that cancels echo in the communication stream.

The communication interface 202 may be any type of interface capable of receiving, sending, and/or processing a communication stream. In one embodiment, the communication interface 202 is implemented within the DSP 108 to initially process the incoming communication streams and/or the outgoing communication streams. In other embodiments, the communication interface 202 may be another type of hardware and/or software.

The connection manager 204, in some embodiments, manages connections of communication streams on the communication line 104 with individual agent terminals 106, or with other components within the DSP 108. Connections of communication streams may include incoming and outgoing phone calls. For example, the communication stream may be an outgoing phone call, and the connection manager 204 may determine a number to dial and initiate dialing of the number. The connection manager 204 may select numbers to call from a database and track call outcomes for a number. In another example, the communication stream may be an incoming phone call.

The process of establishing, initiating, or recognizing a connection with a communication stream is referred to herein as a connection event, or connect event. For example, a connect event may be a pick-up by the phone that is called by the system 100. As another example, a connect event may be a pick-up by the system 100 if someone is calling or otherwise contacting the system 100.

The conversion manager 206 converts incoming data from one format to another format. In one embodiment, the conversion manager 206 converts analog data into digital data. In one embodiment, the conversion manager 206 turns an analog signal into digital data in the form of a stream of numbers. It will be appreciated by those of skill in the art, in light of this disclosure, that the numbers may have a discrete value range. Additionally, the conversion manager 206 may convert digital data from one form to another form. For example, the conversion manager 206 may convert digital voice data representative of the frequencies and amplitude of a caller's voice into digital sound data representative of a specific sound characteristic of the caller's voice. For example, the conversion manager may form a new digital signal representative of the amplitudes, or volume, of the caller's voice, separate from the frequencies of the caller's voice. Other sound characteristics may include, but are not limited to, power, intensity, energy, and so forth.

The conversion may be an algorithmic conversion of the data. In some embodiments, the conversion is a base conversion. For example, the conversion may convert the data to base two. In another embodiment, the conversion is a logarithmic conversion.

In one embodiment, incoming data of the communication stream may be continually received and converted into numbers representative of volume levels. These numbers may be referred to as samples. In one embodiment, the incoming input is the individual digital data created by the digital signal processor.

It will be appreciated by those of skill in the art the number of digital samples depends upon the rate of capture or fidelity of the DSP 108 being used. In some embodiments, the DSP 108 provides up to 6000 samples per second. In another embodiment, the DSP 108 provides about 8000 samples per second. A rate of 8000 sample per second is understood to have capacity to replicate the full range of human voice. In another embodiment, the DSP 108 provides about 16000 samples per second. In another embodiment, the DSP 108 provides about 22500 samples per second. In another embodiment, the DSP 108 provides about 41100 samples per second. Other embodiments may utilize a different sampling rate.

In some embodiments, the data to be converted by the conversion manager 206 is the incoming audio of the communication stream. In other words, the data converted by the conversion manager 206 may represent the audio generated at the called location. The converted data may use any number of bits to represent the volume, energy, or power of the incoming data. In one embodiment, the conversion manager 206 outputs 16 bit samples at a sampling rate of 8000 samples per second. Other embodiments may output samples using a different number of bits. The output of the conversion manager 206 may include a measure of the volume, energy, power, or other metric of the communication stream contained by the one or more frames.

In some embodiments, the buffer 208 receives data from the conversion manager 206 and stores the received data for use by other components of the DSP 108. The buffer 208 may be any type of hardware storage medium capable of storing communication stream data. For example, the buffer 208 may be random access memory (RAM) of the server allocated to the buffer 208. Other embodiments may include different types of buffers.

The frame generator 210, in one embodiment, obtains the converted data, for example, from the buffer 208 and creates a plurality of frames. Each frame contains data from the content stream that covers a period of time. In one embodiment, the frame generator 210 divides the digital data into frames of about 4 milliseconds. In another embodiment, the frame generator 210 divides the digital data into frames of about 8 milliseconds. In yet another embodiment, the frame generator 210 divides the digital data into frames of about 16 milliseconds. In another embodiment, the frame generator 210 divides the digital data into frames of about 32 milliseconds. In other embodiments, other time units may be used for the frames.

As one example, each frame may include approximately 16 ms of data from the content stream. At 8000 samples per second, a 16 millisecond frame will contain approximately 128 samples. If each sample is 16 bits, then the total size of each frame will be approximately 256 bytes of data from the content stream. Other embodiments may use a different time unit that is shorter or longer than 16 ms for the frame, in which case the total size of the frame will vary accordingly. Frames may be of any size or cover any length of time. The frame generator 210 may continuously generate frames as the communication stream is received.

The frame generator 210 further establishes a frame value for each frame. In general, the established value for each frame is representative of a statistical measurement or indicator of the samples within the frame. In one embodiment, the established value for each frame is indicative of an average value of the digital samples in the frame. Other embodiments may use different statistical measurements or indicators.

In some embodiments, the frame generator 210 may convert the established value into an equivalent numerical format. One example of an equivalent numerical format is a logarithmic format, although other embodiments may use other formats. In some embodiments, converting the established value of a frame into a different numerical format may simplify other data analysis operations. For example, noise is typically measured in decibels (a logarithmic unit) and conversion of the digital data into logarithmic format may simplify or enhance comparisons of volume levels, especially for distinguishing between sound characteristics at lower volumes.

In the embodiment where the established value of each frame is the average of samples over a 16 ms period of time, and then the established value is converted into a logarithmic format, the volume level represented by the logarithmic frame values may range from 0 to about 14. Given a discrete range of potential frame values, a specific type of conversion can be implemented to result in a variety of ranges of volume levels. Accordingly, generating logarithmic frame values between about 0 and about 14 from volume levels of the communication stream is just one non-limiting example.

Upon recognizing a connect event and generating frame values in an acceptable format, the DSP 108 can start to examine or analyze the echo-cancelled communication stream to distinguish voice within the communication stream. In one embodiment, the sound analyzer 212 performs some or all of the analysis functions described herein. A more detailed example of the sound analyzer is described below with reference to FIG. 3A.

The intro script trigger 214, in one embodiment, triggers the transmission of an intro script to the person being called. The intro script trigger 214 may trigger the intro script in response to detecting a pattern of volumes that indicate speaking in received frames. For example, the intro script trigger 214 may trigger transmission of an intro script in response to a pattern of volumes in frames that corresponds to a person saying “Hello” and then pausing.

In one embodiment, the intro script trigger 214 triggers transmission of the intro script in response to determining that there is a possibility that the communication stream is connected to a live person. For example, the intro script trigger 214 may act in response to an analysis of volume levels of a group of frames that corresponds to a live person speaking, rather than a recording.

The intro script trigger 214 may include a strong presumption that the communication stream is connected to a live person. Since many laws restrict outcomes that result from mistakenly detecting a recorded voice, this preference for assuming that a live person has been contacted may help in compliance with those laws. In addition, the DSP 108 may continue to monitor and analyze the communication stream after the intro script has been triggered to further refine the detection of recorded voices.

In some embodiments, the intro script trigger 214 triggers transmission of the intro script by directing an agent to perform the script. In other words, the transmission of the triggered script may include live speaking by an agent. In another embodiment, the intro script trigger 214 triggers transmission of the intro script by playing prerecorded audio, such as an audio recording of a person reading the script.

The call transfer manager 216, in one embodiment, manages transfers of communication streams to agent terminals 106. The call transfer manager 216 may transfer a communication stream to an agent terminal 106 in response to a preliminary determination that there is a possibility that the communication stream is connected to a live person. In some embodiments, the call transfer manager 216 may transfer the communication stream in response to the intro script trigger 214 triggering transmission of an intro script.

The call disposition manager 218 disposes of communication streams in response to the DSP 108 determining that the communication stream is connected to a recorded voice. The call disposition manager 218 may disconnect a communication stream in response to detection of a recorded voice.

FIG. 3A depicts a block diagram of one embodiment of the sound analyzer 212 of FIG. 2. The illustrated sound analyzer 212 includes a level analyzer 302, a pattern analyzer 304, and a response analyzer 306. In general, the sound analyzer 212 monitors and evaluates sound characteristics from one or more communication streams. In one embodiment, the sound analyzer 212 distinguishes voices on communication streams. The sound analyzer 212 may perform diagnostics and/or implement one or more algorithms to determine if sound received on a communication stream corresponds to a live person.

The sound analyzer 212 may compare patterns of volume levels in a group of frames to one or more predetermined patterns that indicate a recorded voice. The sound analyzer 212 may also analyze volume levels in a group of incoming frames received while an outbound communication is being transmitted. The sound analyzer 212 may determine that the communication stream is connected to a recorded voice in response to receiving data from frames of an incoming data stream containing a volume that corresponds to talking while the outbound communication is being transmitted.

In one embodiment, the level analyzer 302 analyzes a volume level of one or more frames to determine one or more reference levels. The one or more reference levels may correspond to a volume at which a frame is determined to contain a particular type of content. For example, the level analyzer 302 may determine a silence baseline level that corresponds to a frame which does not contain speaking by the person being called. The level analyzer 302 may also establish a reference talking volume level that corresponds to a volume at which the person being called is talking. An embodiment of the level analyzer 302 is described in greater detail in relation to FIG. 3B below.

The level analyzer 302 also analyzes the volume level of a group of frames to determine a status of the communication stream. The status may be undetermined, may be determined to be a live person, or may be determined to be a recorded voice. Determination of the status of the communication stream may be an ongoing process as the communication stream is received. The sound analyzer 212 may continue to determine the status of the communication stream as an agent interacts with the communication stream. For example, the sound analyzer 212 may initially determine that the status of the communication is from a live person or is undetermined. As the analysis of the communication stream continues, the determination may change to be “recorded voice,” at which point the call may immediately be disposed of. Similarly, the sound analyzer 212 may initially determine that the status of the communication is “undetermined.” As the analysis of the communication stream continues, the determination may change to be “live voice.” As the analysis continues the determination may change until a determination of “recorded voice” is obtained, at which point the call may immediately be disposed of. The sound analyzer may make an initial assumption that the status is “undetermined” or “live voice.”

The pattern analyzer 304, in one embodiment, compares patterns detected in an incoming component of the communication stream to one or more predetermined patterns to detect a recorded voice. The pattern analyzer 304 may use the silence baseline volume and the reference talking volume to determine frames in which speech is being transmitted via the incoming component of the communication stream. The pattern analyzer 304 may determine patterns of speech in the incoming component of the data stream.

For example, the pattern analyzer 304 may detect five periods of speech separated by five periods of silence. The pattern analyzer 304 may interpret this pattern as five consecutive words, and determine that this pattern may be indicative of a recorded voice. In another example, the pattern analyzer 304 may detect periods of speech separated by relatively short periods of silence. The pattern analyzer 304 may determine that this pattern is indicative of a recorded voice.

The response analyzer 306, in one embodiment, determines the status of the communication stream by analyzing a response in the incoming component of the communication stream to an outgoing message. The response analyzer 306 leverages a typical response to hearing speech on the other end of a connection. Many people respond to hearing speech with silence. While the person on the other end of the communication stream listens to a message being transmitted from the server 102, the response analyzer 306 detects silence from the incoming component of the communication stream and determines that the status of the communication stream is not a recorded voice. Conversely, if the response analyzer 306 detects that speech on the incoming component of the communication stream continues while an outgoing message is being transmitted from the server 102, the response analyzer 306 may determine that the status of the communication stream is a recorded voice. In one embodiment, the response analyzer 306 may analyze the incoming component of the communication stream during transmission of the intro script.

FIG. 3B depicts a block diagram of one embodiment of the level analyzer 302 of FIG. 3A. The level analyzer 302 includes a silence baseline generator 402, a talking level generator 404, and a sound filter 406. The level analyzer 302 determines one or more reference volume levels for the communication stream.

The silence baseline generator 402, in one embodiment, detects a silence baseline volume that corresponds to a period of relative silence on the communication stream. The period of relative silence represents the ambient sound in the environment and interference sound present on the communication line. The silence baseline is used to help determine which frames include something other than silence, for example, speech.

In some embodiments, the talking level generator 404 detects a reference talking volume that corresponds to speech on the incoming portion of the communication stream. The reference talking volume is generally a higher volume than the silence baseline volume. As explained above, in some embodiments using a logarithmic value makes differences between the silence baseline volume and the reference talking volume more distinct.

The sound filter 406, in one embodiment, identifies volume levels that correspond to neither silence nor speech. The sound filter 406 may cause the level analyzer 302 to disregard these sounds when determining the silence baseline volume and/or the reference talking volume. At higher noise levels, the difference between the volume level for voice versus the ambient sound is greater than at lower levels.

Additionally, the sound filter 406 may operated on the concept that a human speaker will typically attempt to speak louder than ambient sounds in order to be heard. At louder or higher noise levels, it may take more word frames to determine that the noise is speaking or voice. At lower levels, the ambient is quieter, so it takes a smaller volume level difference to assume voice, as well as a shorter word frame. With this mind, large amplitude increases that are not long enough in duration can be ruled or filtered out. Thus, for example, a background bark from a dog may increase the volume level, but the duration of that increase, or the duration of the word frame is such that it would not be associated with speaking. Similarly, a child's scream may be of a significantly longer duration such that the length of the word frame may not be associated with speaking.

The following examples may be useful to illustrate some of the further functionality of the DSP 108 and, in particular, the sound analyzer 212.

When determining whether sound during a call is a live voice versus a recording voice or other sound, an initial volume level be determined or set to be a silence baseline. That silence baseline is kept at the value of the initial volume level until a difference in the volume level is detected, which difference may be an increase or decrease. This differentiation may represent a differentiation in sound amplitude. In one embodiment, a big differentiation in volume levels is determined to be voice and a small differentiation is determined to be noise. Voice may be live or recorded. A recorded voice is typically associated with an answering machine. Noise may be any number of sounds that occur over a telephone line. Some examples of noise include static or other system noises, background noises such as music, appliances, or any number of sounds that are not voice.

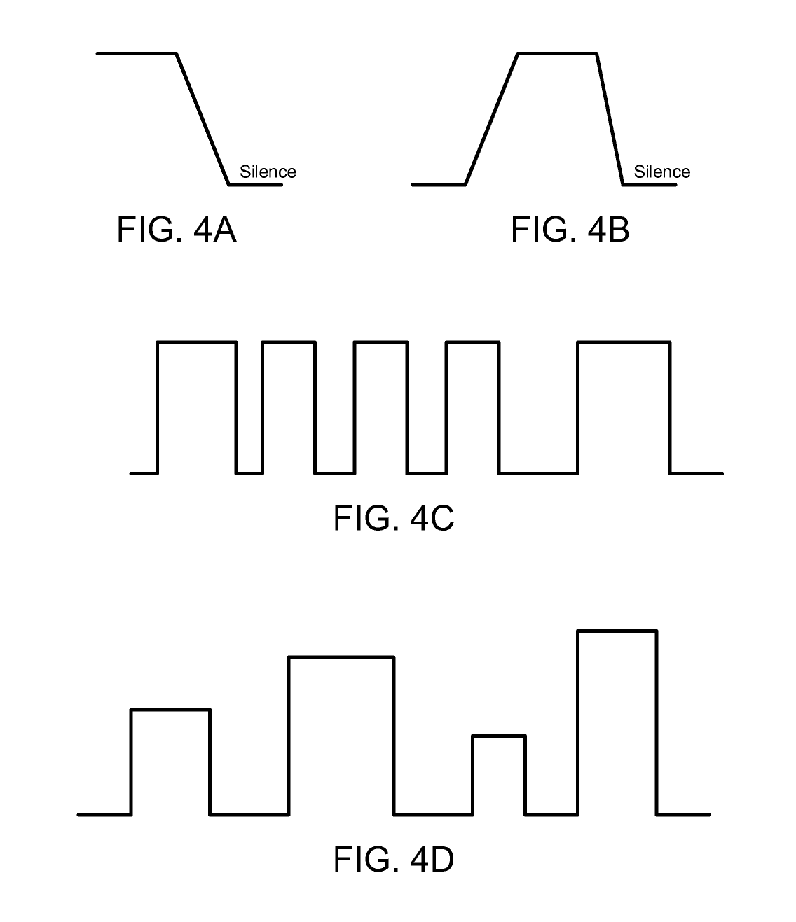

In one example, the silence baseline generator 302 establishes a silence baseline when a drop in sound occurs, as shown in FIG. 4A. The waveform depicted in FIG. 4A represents a situation in which a high volume level was detected at the beginning of a communication stream and then the volume level decreases. In another example, the silence baseline generator 302 establishes a silence baseline when an increase in sound occurs, as shown in FIG. 4B. The waveform depicted in FIG. 4B represents a situation in which a low volume level is present at the beginning and then spikes up. In these examples, the lower volume level may be designated as the new silence baseline. These lower volume levels are considered to be “silence” even if the volume levels are well above normal noise level values, as long as there is a distinguishable change between the lower and higher volume levels.

In other embodiments, the initial volume level may be set as the silence baseline value, regardless of the actual volume level. The silence baseline volume subsequently may be reset at a different level in response to a determination that the silence baseline level should be lower. For example, in FIG. 4A, the silence baseline level initially may be set at the higher level and then reset to the lower level. In contrast, in FIG. 4B, the silence baseline level initially may be set at the lower level and then maintained at the lower level even after the higher volume level is detected.

In some embodiments, the distinction between voice and other noise is determined based on the length of an elevated volume level in comparison to the silence baseline. In one example, a volume level which exceeds the silence baseline by a predetermined amount for a predetermined time is considered voice. The predetermined amount or volume level may be one or more of the reference volume levels (e.g., 0-14 levels) used for comparison and analysis. One such reference volume level may be a reference talking volume that is a volume level associated with speaking.

In one embodiment, the establishment of voice versus noise may also be determined by measuring the number of “word frames” created, where a word frame is a group of frames at an increased volume level from the silence baseline. Thus, a word frame may be the equivalent of the length of the plateau in depicted in the waveform of FIG. 4B. The number of these word frames may indicate voice versus noise. For example, standard words may be at least as long as 5 to 10 frames, whereas an increase for 1 to 3 frames is usually just noise.

In one embodiment, differences in volume levels at lower volume levels may be smaller to indicate voice versus noise, while differences in volume levels at higher volume levels may need to be bigger to indicate voice versus noise. For example, where a silence baseline or current volume level is below 5, an increase of 1 volume level may be associated with voice instead of sound. Where a silence baseline or current volume level is above 5, a larger difference of 2, for example, may need to occur to assume voice versus noise. Noise may be associated with 1 or 2 frames of sustained increase at the lower levels, whereas voice may be established at 3 or more frames. These numbers are merely examples, and other numbers or values may be used in different embodiments.

In one embodiment, intermediary sounds from the communication stream may be filtered out by analyzing the incoming component of the converted data to filter frames having a volume level corresponding to sounds other than a speaker's voice. For example, where the volume level associated with the incoming component has a lower value, it typically means there is very little sound coming from the background or ambient. Where there is louder background noise, people instinctively may speak louder in order to be heard over the ambient noise. Thus, the volume level associated with voice is higher when there is more ambient or background noise and lower when there is less ambient or background noise. Thus, at higher levels of noise the amplitude of voice is going to be a bigger difference over ambient sound, or in other words a greater magnitude of difference. Under these rules, the silence baseline can be reset to a higher value to essentially filter out sounds other than a speaker's voice, which other sounds might be correspond to spikes in volume levels. For example, where a noise such as a dog bark will be at a different volume level differential from the silence baseline and/or a different duration of time than a human speaking voice, the system can ignore or filter out these sounds and/or adjust the silence baseline or reference talking volume to eliminate or minimize the influence of these sounds on the volume level analysis.

In one embodiment, the pattern analyzer 304 interprets or distinguishes between live voice, recorded voice or other sounds. For example a regular live voice may be represented as shown in FIG. 4B. Where the silence baseline is established and then the voice is established by a raise of volume level. The level is sustained for a time indicating talking. Then the there is silence for a time. This is a natural pattern for a live voice. A person answers “hello” or with some other word or phrase and then waits for an expected reply.

Where there is an initial greeting or sound, followed by a relatively quiet pause, the pattern analyzer 304 may perform additional analysis to determine if the sound corresponds to a live voice. However, if there a long sustained duration of sound consistent with voice, the pattern analyzer 304 may rely on a strong probability that the voice is recorded. Normal phone conversation openings typically do not contain long run-on portions, which is more typical of answering machines with predetermined messages to deliver. The pattern analyzer 304 recognizes these and other patterns and provides feedback to the sound analyzer 212, accordingly.

If the agent or operator of the system speaks at any time during sound levels that are determined to be live voice, and there is not an immediate or timely stop or drop in volume level, then the pattern analyzer 304 may determine that the communication stream is an answering machine or other recorded voice. There is a relatively high probability that a live person would not continue to talk when the other party to the conversation starts talking. In contrast, a recorded voice would likely continue playing regardless of when the other party talks. This is one of many ways the pattern analyzer 304 can distinguish live voice from recorded voice.

In one embodiment, the pattern analyzer 304 analyzes the length and/or frequency of the pauses between higher volume levels, as shown in FIG. 4C, to distinguish between live voice and recorded voice. As one example, live voice may have a cadence and pace that is different than recorded voices, and these patterns can be detected and analyzed to distinguish between live voice and recorded voice.

Other patterns unique to live voice and/or recorded voice also may be used to distinguish between them. For example, as shown in FIG. 4D, the variation of volume differentials is different between live voice and recorded voice. Live voice typically has greater variation in volume levels than recorded voice, which can sometimes be more monotone. These patterns can be stored and compared to the patterns established in the communication stream. Accordingly, patterns that correspond to recorded voice or to live voice can be determined and stored and used by the pattern analyzer 304 to distinguish between live voice and recorded voice. Some of the factors that can be patterned are length and frequency of voice, length and frequency of pauses or periods of reduced voice, magnitude of voice and volume level, variation in volume levels, and the like.

In one embodiment, an array of volume levels which span the possible range of frame values (either native or as logarithmic values, for example) as limited by the DSP 108 is initialized to zero. In one embodiment, the range of frame values is represented by 14 entries.

As each frame value is added into the array, a comparison of the new frame value is made with a stored value. If a large difference in volume level, as represented by the converted data value, is detected, then a boundary differential state begins and the lower volume level is established as a silence baseline level. The silence baseline level may be established even if the state or array entry at the beginning of the boundary differential state has a volume level which can be considered ‘noise’. This initializes a counter for the duration of the heightened noise or silence with time adding to the counter in an attempt to determine the duration.

Once a noise, live voice word, or some random sound such as a dog bark or other sound has finished and the volume level drops back to the then current silence baseline level, a counter begins to determine the length of volume level at or near the silence baseline. Normal human live speech patterns may dictate a certain latitude for expectation in response time. So, if the duration of volume level at the then current silence baseline reaches the expected length of time, then live voice most likely occurred on the ‘customer’ end, live voice is presumed, and a trigger state is changed to launch a trigger state change that sends a signal initiating a conversation with a live agent.

If a word boundary continues for a longer than acceptable period of time, then the speech may be designated as recorded voice and may be discarded as an answering machine. Alternatively, if the initial amount of time for nominal silence is exceeded (multiple word boundaries with no expected length of silence allowing for interruption), then again the received input may be designated as recorded voice and discarded.

This method is then continued in order to establish when the ‘customer’ voice is being used to present the agent with visual cues that the person is speaking and direct their attention to said person in order to handle call. Various states may be used in order to provide more accurate reporting of what kind of voice pattern the sound analyzer 212 receives or expects to receive (e.g., phrase, answering machine, single word, etc.) in order to optimize user experience and provide acceptable customer service.

In one embodiment, if no differential in volumes is apparent during initial sound volume comparisons, then a prompt may be used to illicit a response from the other party. This prompt may be used to then motivate the customer to provide a sample of volume differential. If a noise is then detected, distinguishing sound features may be recognized and determined to be a live or recorded voice, or other sound. Otherwise, the call may be determined to be dead air caused by any number of possible reasons such as accidental hang up, mute button pressed, etc., and the call may be terminated.

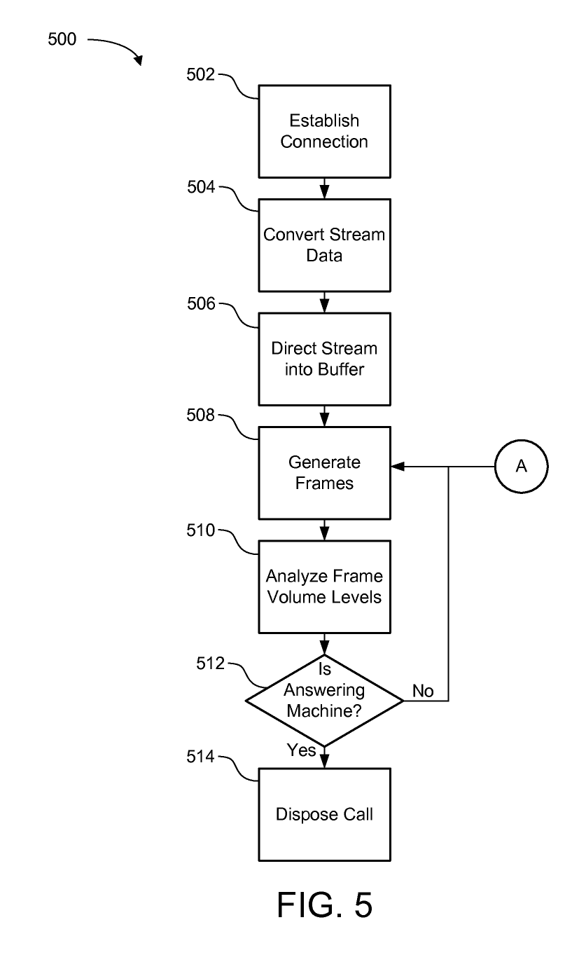

FIGS. 5-7 depict flowchart diagrams showing one embodiment of a method 500 for distinguishing a voice. The method 500 is, in certain embodiments, a method of use of the system and apparatus of FIGS. 1-3, and will be discussed with reference to those figures. Nevertheless, the method 500 may also be conducted independently thereof and is not intended to be limited specifically to the specific embodiments discussed above with respect to those figures.

As shown in FIG. 5, the connection manager 204 establishes 502 a connection. The established connection may be any type of communication stream including incoming or outgoing telephone call, video call, VOIP connection, or the like. The connection may be established by the system user, or by someone calling into the system. The communication stream may be established 502 locally or from a foreign location. The communication interface 202 may manage transmission of the communication stream to the conversion manager 206 which may convert 504 the input stream to an acceptable digital format. Alternatively, if the communication stream is already in an acceptable format, then the conversion manager 206 may leave the original data in the same format. The converted data is then directed 506 into the buffer 208.

Data from the communication stream may be accessed from the buffer 208 by the frame generator 210. The frame generator 210 may process the data from the buffer 208 to generate 508 a plurality of frames, as described above. Each frame generated 506 by the frame generator 210 may include data from a period of time for the communication stream or may include a predetermined amount of data. For example, the frame generator 210 may generate 506 frames covering approximately 16 ms of time. The frame generator 210 also may assign a frame value to represent the data within the frame, as described above.

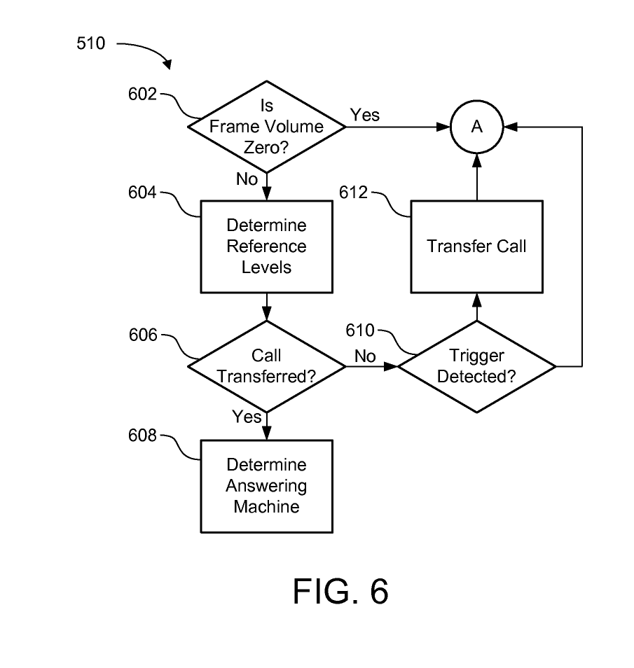

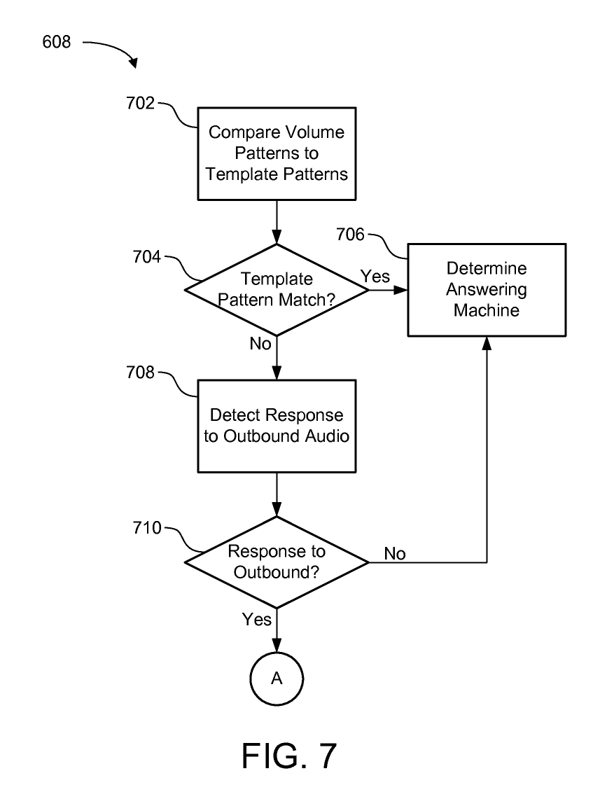

The sound analyzer 212 may analyze 510 frame volume levels to detect if a recorded voice is supplying an incoming component of the communication stream. One embodiment of the analysis performed by the sound analyzer 212 is described in greater detail in relation to FIGS. 6 and 7 below.

If the sound analyzer 212 detects 512 that the communication stream includes a recorded voice, the call disposition manager 218 may dispose 514 of the call. If the sound analyzer 212 does not detect 512 that the communication stream includes a recorded voice, the method 500 continues to generate 508 frames and analyze 510 frame volume levels (or other sound characteristics).

FIG. 6 depicts a flowchart diagram showing one embodiment of a method for analyzing 510 frame volume levels to distinguish a voice. As shown in FIG. 6, the sound analyzer 212 may determine 602 if a frame volume is effectively zero. In some embodiments, the analysis 510 begins before the communication stream is connected in order to aid quick call processing. Thus, one or more initial frames may have a zero volume. Frames having zero volume may be indicative of the communication stream not yet being connected, and in response to determining 602 that a frame volume is zero, the method 500 may return to point A in FIG. 5 to resume collecting data.

If the frame volume is not zero, the level analyzer 302 may determine 604 one or more reference levels. The reference levels may include a silence baseline volume and a reference talking volume. The call transfer manager 216 may determine 606 if the call has been transferred to an agent terminal 106. If the call has not been transferred, the sound analyzer 212 may analyze volume levels in a group of frames to determine if a transfer trigger is present. If the sound analyzer 212 detects 610 a transfer trigger, the call transfer manager 216 may transfer 612 the communication stream to an agent terminal 106. An example of a transfer trigger may be a relatively short period at or above the reference talking volume followed by a period of time near the silence baseline volume. This pattern in the volume level may correspond to a live person saying “Hello?” followed by a pause. The transfer trigger generally serves to indicate that there is some predicted probability that the communication stream is not connected to a recorded voice. If the sound analyzer 212 does not detect 610 a transfer trigger, the method 500 returns to A in FIG. 5 to resume collecting data.

If the call transfer manager 216 detects 606 that the call has been transferred, the sound analyzer 212 analyzes frames to determine 608 the presence of a recorded voice. One embodiment of determining 608 the presence of a recorded voice is described in greater detail in relation to FIG. 7 below.

FIG. 7 depicts a flowchart diagram showing one embodiment of a method for determining 608 the presence of a recorded voice using template patterns and response analysis. As shown in FIG. 7, the pattern analyzer 304 compares 702 the volume in a group of frames to one or more predetermined template patterns. If the pattern analyzer 304 determines 704 that the volume in the group of frames corresponds to one of the predetermined template patterns, the pattern analyzer 304 may determine 706 that the communication stream is connected to a recorded voice.

If the pattern analyzer 304 does not determine 704 that the volume in the group of frames corresponds to one of the predetermined template patterns, the response analyzer 504 may detect 708 a response to outbound audio. If the response analyzer 504 determines 710 that the inbound component of the communication stream indicates no response to the outbound audio, the response analyzer 504 may determine 706 that a recorded voice is connected to the communication stream. If response analyzer 504 determines 710 that there is a response to the outbound audio, the method 500 may return to A in FIG. 5 to resume collecting data.

Embodiments of the system, method, and apparatus described herein provide improved reliability in distinguishing voices. Embodiments may also improve compliance with various laws governing communication with large numbers of people. Furthermore, embodiments may improve relationships with potential customers or clients by improving the responsiveness of autodialed conversations.

It should also be noted that at least some of the operations for the methods may be implemented using software instructions stored on a computer useable storage medium for execution by a computer. As an example, an embodiment of a computer program product to distinguish a voice includes a computer useable storage medium to store a computer readable program that, when executed on a computer, causes the computer to perform operations described herein.

Embodiments of the invention can take the form of an entirely hardware embodiment or an embodiment containing both hardware and software elements. In one embodiment, the invention is implemented in software operating on hardware, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for distinguishing voice, the system comprising:
a server comprising:
a communication interface to process an incoming communication stream, the communication interface comprising an echo canceller to cancel echo in the communication stream;
a frame generator to operate on a processor of the server, the frame generator to generate a plurality of frames from the communication stream, each of the plurality of frames containing data for a period of time from the communication stream, and to assign a frame value to each of the plurality of frames; and
a sound analyzer to determine a status of the communication stream by analyzing the frame values of the plurality of frames.

2. The system of claim 1, wherein the server further comprises a call transfer manager to manage transfer of the communication stream to one of a plurality of agent terminals.

3. The system of claim 2, wherein the plurality of agent terminals is in communication with the server, the agent terminals to receive the communication stream transferred from the server.

4. The system of claim 1, wherein the frame generator is further configured to assign the frame value of each frame according to a logarithmic scale.

5. The system of claim 1, wherein the frame generator is further configured to generate frames containing data for approximately sixteen ms each from the communication stream.

6. The system of claim 1, wherein the sound analyzer determines the status of the communication stream by analyzing differentials in the frame data of the plurality of frames.

7. The system of claim 1, wherein the sound analyzer comprises a level analyzer to determine the status of the communication stream by determining a silence baseline.

8. The system of claim 7, wherein the level analyzer determines a differential in a volume level and the silence baseline.

9. The system of claim 1, wherein the sound analyzer determines the status of the communication stream by comparing a volume level to a pattern.

10. The system of claim 1, wherein the sound analyzer determines the status of the incoming communication stream as a recorded voice in response to detecting a volume level of a group of frames for the incoming communication stream during speech in an outgoing communication stream.

11. The system of claim 1, wherein the status detected by the sound analyzer is selected from the group consisting of a recorded voice, a live voice, and other noise.

12. The system of claim 1, wherein the server further comprises an intro script trigger to initiate an intro script in response to detection of a pattern in a volume level in a group of frames that indicates a possibility of a connection with a live person.

13. The system of claim 12, wherein the sound analyzer determines the status of the communication stream by detecting a response to the intro script in an incoming volume level of the group of frames, wherein an incoming volume level that corresponds to speaking during a portion of transmission of the script indicates a recorded voice.

14. The system of claim 1, further comprising a call disposition manager to dispose of the communication stream in response to determining that the communication stream comprises a recorded voice.

15. A server for distinguishing a voice, the server comprising:
a processor;
a communication interface to process a communication stream, the communication interface comprising an echo canceller to cancel echo in the communication stream;
a frame generator to operate on a processor of the server, the frame generator to generate a plurality of frames from the communication stream, each of the plurality of frames containing data for a period of time from the communication stream, and to assign a frame value to each of the plurality of frames; and
a sound analyzer to determine a status of the communication stream by analyzing the frame values of the plurality of frames.

16. The server of claim 15, further comprising a level analyzer to detect a silence baseline volume for the communication stream by analyzing the frame values to determine a volume level corresponding to silence.

17. The server of claim 15, further comprising a level analyzer to detect a reference talking volume for the communication stream by analyzing the frame values to determine a volume level corresponding to talking.

18. The server of claim 15, further comprising a level analyzer to filter intermediary sounds from the communication stream by analyzing the frame values to filter frames having a volume level corresponding to noise other than live voice or recorded voice.

19. The server of claim 15, further comprising a buffer to receive the communication stream.

20. A computer program product comprising:
a computer useable storage medium to store a computer readable program that, when executed on a processor of a computer, causes the computer to perform operations for distinguishing a voice, the operations comprising:
directing a communication stream into a buffer;
generating a plurality of frames, each frame of the plurality of frames containing data for a period of time from the communication stream;
generating frame values to designate sound characteristics of the plurality of frames;
establishing a silence baseline using at least some of the frame values of the plurality of frames;
determining a differential between a volume level and the silence baseline; and
comparing patterns of volume levels to template patterns to detect one or more of a recorded voice and a live voice.

21. The computer program product of claim 20, further comprising:
detecting a pattern in a volume level in a group of frames that indicates a possibility of a connection with a live person; and
initiating transmission of a script in response to detecting the pattern in the volume level in the group of frames.

22. The computer program product of claim 20, further comprising:
initially presuming that data in the frames corresponds to a live voice; and
repeating the operation of comparing the patterns of volume levels to the template patterns until the recorded voice or the live voice is detected.

23. The computer program product of claim 22, further comprising either disposing of the communication stream in response to detecting the recorded voice or playing an intro script of to confirm detecting the live voice.
